(19) United States
(12) Patent Application Publication
(10) Pub. No.: US 2024/0346639 A1
(43) Pub. Date: Oct. 17, 2024

(54) PRINTING APPARATUS, PRINTING SYSTEM, AND CONTROL METHOD OF PRINTING APPARATUS

(71) Applicant: CANON KABUSHIKI KAISHA, Tokyo (JP)

(72) Inventor: TAKASHI YABE, Chiba (JP)

(21) Appl. No.: 18/628,963

(22) Filed: Apr. 8, 2024

(30) Foreign Application Priority Data
Apr. 12, 2023 (JP) 2023-064872

(51) Int. Cl. G06T 7/00; H04N 1/00

(52) U.S. Cl. CPC G06T 7/0004; H04N 1/00822; G06T 2207/30144

(57) ABSTRACT

To make it possible to perform diagnosis of a part fault with accuracy by correctly grasping the periodicity of an image defect in a case of double-sided printing. The periodicity of a defect is determined by performing processing that is in accordance with an operation mode in a case where double-sided printing is performed and which achieves consistency between page order in a case where printing is performed in the printing unit and page order in a case where reading is performed in the reading unit.

### BACKGROUND

### Field

The present disclosure relates to a technique to diagnose a fault of a printing apparatus.

### Description of the Related Art

Conventionally, there is a technique to diagnose a fault of a printing apparatus forming an image on a sheet using color materials based on print results. Japanese Patent Laid-Open No. 2019-78916 has disclosed a diagnostic technique to estimate a part corresponding to periodicity as a fault portion by estimating the conveyance interval of a plurality of sheets by using a sheet sensor and determining whether or not there is periodicity based on the estimated conveyance interval and the position of an image defect detected from each sheet.

Some printing apparatuses have the double-sided printing function capable of printing both on the obverse side and on the reverse side of a sheet and some printing apparatuses have an alternate double-sided mode and a cyclic double-sided mode as the operation mode thereof (see Japanese Patent Laid-Open No. 2011-197392).

### SUMMARY

Even in a case where the same input data is processed, the processing order (image formation order) of pages at the time of printing is different between the alternate double-sided mode and the cyclic double-sided mode, but the results of the print output are the same for both modes. Because of this, the order of pages of the read image obtained by scanning a printed material for inspection is common to both modes, but the processing order of pages at the time of printing is different, and therefore, it is not possible to correctly grasp the periodicity of an image defect across pages due to the difference in the processing order of pages. In this case, it is also not possible to correctly diagnose a part fault based on the periodicity of a detected image defect.

The printing apparatus according to the present disclosure is a printing apparatus including: a printing unit configured to perform printing on a printing medium by using color materials, and having a double-sided printing function; a reading unit configured to generate a read image by reading a printed medium output from the printing unit; and an inspection unit configured to inspect whether or not there is a defect on the printed medium based on the read image, the printing apparatus further including: one or more memories storing instructions; and one or more processors executing the instructions to perform: determining periodicity of a detected defect based on inspection results by the inspection unit for a plurality of the printed printing media output successively, wherein the double-sided printing function includes two operation modes in which processing order of pages is different and the periodicity is determined based on results of processing that is in accordance with an operation mode in a case where double-sided printing is performed in the printing unit and which achieves consistency between page order in a case where printing is performed in the printing unit and page order in a case where reading is performed in the reading unit.

Further features of the present disclosure will become apparent from the following description of exemplary embodiments with reference to the attached drawings.

### BRIEF DESCRIPTION OF THE DRAWINGS

FIG. 1 is a diagram showing a configuration example of a printing system;

FIG. 2 is a cross-sectional diagram showing an internal structure of a printing apparatus;

FIG. 3 is an explanatory diagram of an alternate double-sided mode;

FIG. 4 is an explanatory diagram of the alternate double-sided mode;

FIG. 5 is an explanatory diagram of a cyclic double-sided mode;

FIG. 6 is an explanatory diagram of the cyclic double-sided mode;

FIG. 7 is a block diagram showing a hardware configuration of the printing apparatus, an external controller, and a client PC;

FIG. 8 is a diagram showing a relationship between FIGS. 8A and 8B, and FIGS. 8A and 8B are flowcharts showing a flow of the operation of the printing apparatus;

FIG. 9A and FIG. 9B are each a diagram showing one example of a filter;

FIG. 10 is a flowchart showing details of part diagnosis processing;

FIG. 11A to FIG. 11E are each a diagram showing one example of a page on which a spot-shaped defect is detected;

FIG. 12 is a diagram showing a relationship between image formation order and passing timing in the alternate double-sided mode;

FIG. 13 is a diagram showing a relationship between image formation order and passing timing in the cyclic double-sided mode; and

FIG. 14 is a diagram showing one example of part period information.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

### First Embodiment

### <System Configuration>

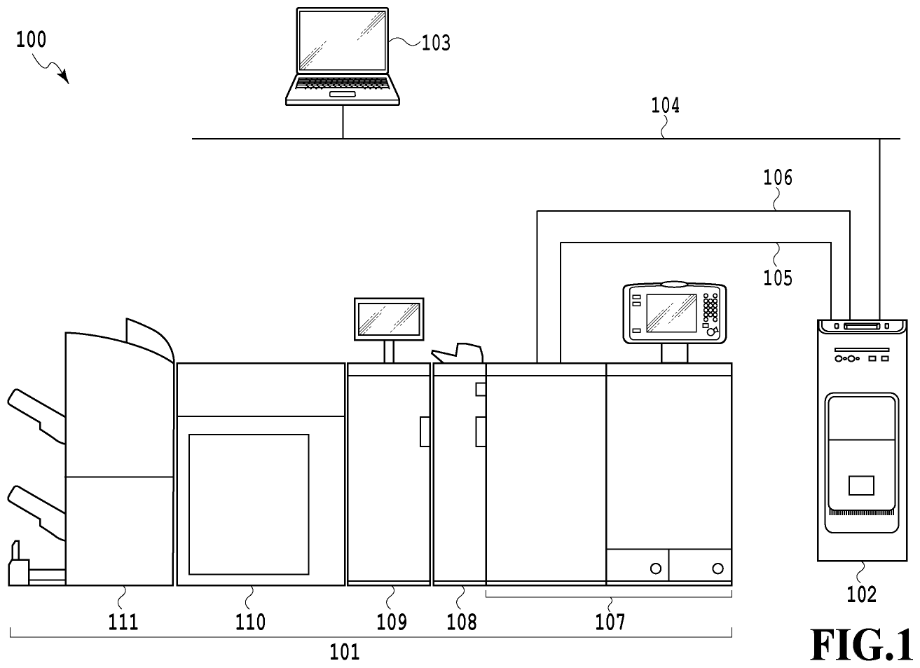

FIG. 1 is a diagram showing a configuration example of a printing system (image processing system) according to the present embodiment. A printing system 100 shown in FIG. 1 includes a printing apparatus (image forming system) 101 and an external controller 102. The printing apparatus 101 and the external controller 102 are connected so as to be capable of communication via an internal LAN 105 and a video cable 106. The external controller 102 is connected with a client PC 103 so as to be capable of communication via an external LAN 104.

It is possible for the client PC 103 to instruct the external controller 102 to perform printing via the external LAN 104. In the client PC 103, a printer driver is installed, which has the function to convert print processing-target image data into page description language (PDL) that the external controller 102 can process. It is possible for a user who desires to perform printing to give instructions to perform printing via the printer driver from various applications installed in the client PC 103 by operating the client PC 103. The printer driver transmits PDL data to the external controller 102 based on instructions to perform printing from a user. The external controller 102 generates a print job including the PDL data received from the client PC 103 and inputs the print job to the printing apparatus 101. In this print job, print setting information indicating what type of printing is performed by using PDL data, that is, indicating the number of copies to be printed, the number of pages per copy, the size/type of a sheet used for printing, double-sided printing, bookbinding and the like is included.

Next, the printing apparatus 101 is explained. The printing apparatus 101 includes a plurality of modules having different functions so as to be capable of processing, such as inspection of print results and bookbinding. The printing apparatus 101 of the present embodiment has a printing module 107, an inserter 108, an inspection module 109, a stacker 110, and a finisher 111. In the following, each module is explained.

The printing module 107 forms an image on a printing medium (sheet) for each page in accordance with an input print job and discharges a sheet on which an image is formed (printed sheet). The printed sheet discharged from the printing module 107 is conveyed to the inserter 108, the inspection module 109, the stacker 110, and the finisher 111 in this order.

The printing module 107 forms (prints) an image on a sheet supplied from a sheet feeding unit by using color materials (toner). The inserter 108 is a device inserting, for example, a partition sheet or the like for separating a group of a series of sheets conveyed from the printing module 107 at an arbitrary position. The inspection module 109 is a device performing inspection for a printed sheet output from the printing module 107, that is, a device detecting an image defect. Specifically, the inspection module 109 reads an image formed on a printed sheet and determines whether there is a scratch or soiling in the image formed on the printed sheet (whether or not the image is normal) by comparing the obtained read image with a reference image registered in advance. The stacker 110 is a device capable of stacking a large number of printed sheets. The finisher 111 is a device capable of performing finishing processing, such as stapling processing, punching processing, and saddle stitch bookbinding processing, for a conveyed printed sheet. The printed sheet for which the finishing processing has been performed is discharged onto a predetermined discharge tray.

In the system configuration example in FIG. 1, the external controller 102 is connected to the printing apparatus 101, but the configuration of the printing system is not limited to this. For example, the configuration may be one in which the printing apparatus 101 is connected to the external LAN 104 and the print job including PDL data is input from the client PC 103 to the printing apparatus 101 without the intervention of the external controller 102. In this case, the analysis, interpretation, and rasterization of the PDL data included in the print job are performed by the printing apparatus 101.

### <Internal Structure of Printing Apparatus>

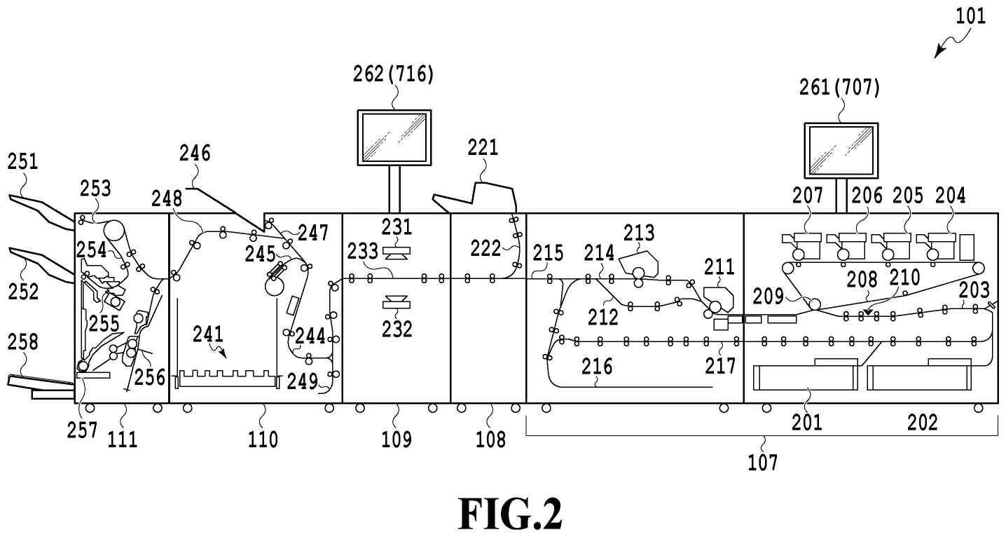

FIG. 2 is a cross-sectional diagram showing the internal structure of the printing apparatus 101. In the following, with reference to FIG. 2, the operation of each module configuring the printing apparatus 101 is explained.

The printing module 107 comprises sheet feed decks 201 and 202 storing various sheets. The sheet located at the uppermost position of the sheets stored in each sheet feed deck is separated one by one and fed to a conveyance path 203. A detection sensor 210 is provided on the conveyance path 203 and detects passing timing of each sheet. For example, the detection sensor 210 detects passing timing of the front end of the sheet in the conveyance direction. In the operation by the double-sided printing function, after the first side of the sheet passes, the sheet is reversed in a reversing path 216 and guided to a double-sided conveyance path 217 and the second side of the sheet passes and detection is performed again.

Each of image formation stations 204 to 207 includes a photoconductor drum (photosensitive member) and each forms a toner image on the photoconductor drum by using toner of a color different from one another. Specifically, each of the image formation stations 204 to 207 forms a toner image by using toner of yellow (Y), magenta (M), cyan (C), and black (K), respectively. The toner image of each color formed in the image formation stations 204 to 207 is transferred in order onto an intermediate transfer belt 208 in a superimposition manner (primary transfer). The toner image transferred onto the intermediate transfer belt 208 is conveyed up to a secondary transfer position 209 in accordance with the rotation of the intermediate transfer belt 208. At the secondary transfer position 209, onto the sheet conveyed through the conveyance path 203, the toner image is transferred from the intermediate transfer belt 208 (secondary transfer). The sheet for which the secondary transfer has been performed is conveyed to a fixing unit 211. The fixing unit 211 comprises a pressure roller and a heating roller. Fixing processing to fix the toner image onto the sheet is performed by applying heat and pressure to the sheet while the sheet is passing between these rollers. The sheet having passed through the fixing unit 211 is conveyed to a connection point 215 of the printing module 107 and the inserter through a conveyance path 212. In this manner, a color image is formed (printed) on the sheet.

In a case where further fixing processing is necessary in accordance with the type of sheet, the sheet having passed through the fixing unit 211 is guided to a conveyance path 214 in which a fixing unit 213 is provided. The fixing unit 213 performs further fixing processing for the sheet that is conveyed through the conveyance path 214. The sheet having passed through the fixing unit 213 is conveyed to the connection point 215. Further, in the operation by the double-sided printing function, the sheet on the first side of which an image is formed and which is conveyed through the conveyance path 212 or the conveyance path 214 is guided to the reversing path 216. The sheet reversed in the reversing path 216 is guided to the double-sided conveyance path 217 and conveyed up to the secondary transfer position 209. Due to this, at the secondary transfer position 209, the toner image is transferred onto the second side, which is the opposite side of the first side of the sheet. After that, by the sheet passing through the fixing unit 211 (and the fixing unit 213), the formation of the color image on the second side of the sheet is completed. Then, as described in the problem to be solved, the operation mode at the time of double-sided printing includes the alternate double-sided mode and the cyclic double-sided mode.

### <Operation Mode at the Time of Double-Sided Printing>

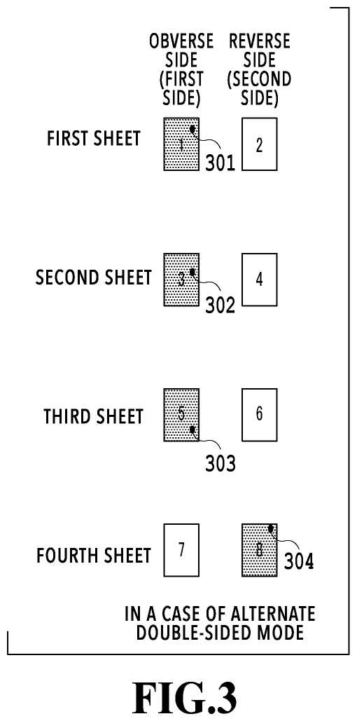

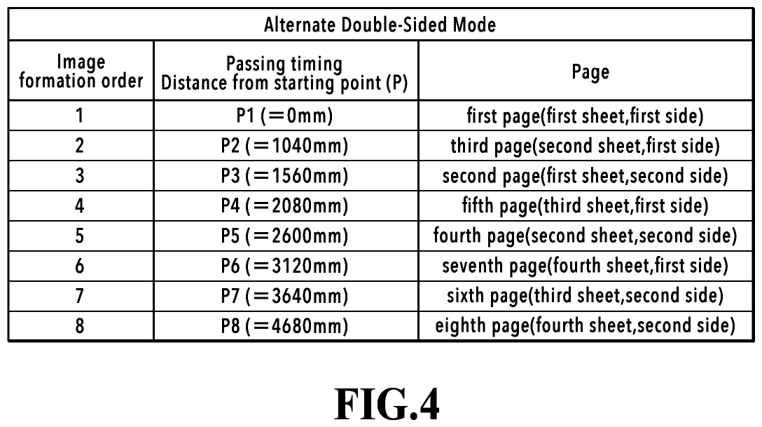

FIG. 3 and FIG. 4 are each an explanatory diagram of the alternate double-sided mode. FIG. 3 shows the order of pages in a case where the printed sheets are output from the printing module 107. In FIG. 3, black points 301 to 304 each show one example of a spot-shaped defect that occurs in a case where there is an abnormality in the intermediate transfer belt. FIG. 4 is a table putting together relationships between the timing at which the sheet passes the detection sensor 210 and the page to be formed on the sheet after the sheet passes. Details of this table will be described later.

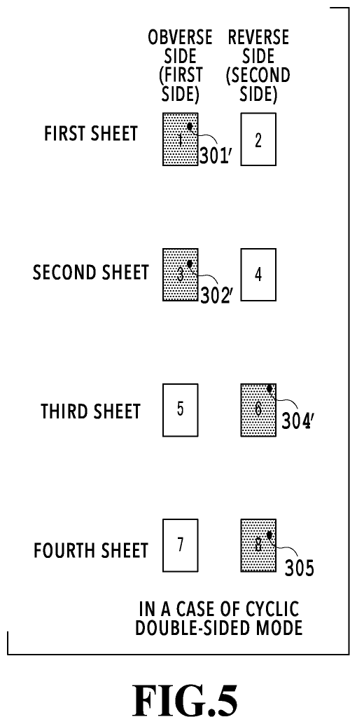

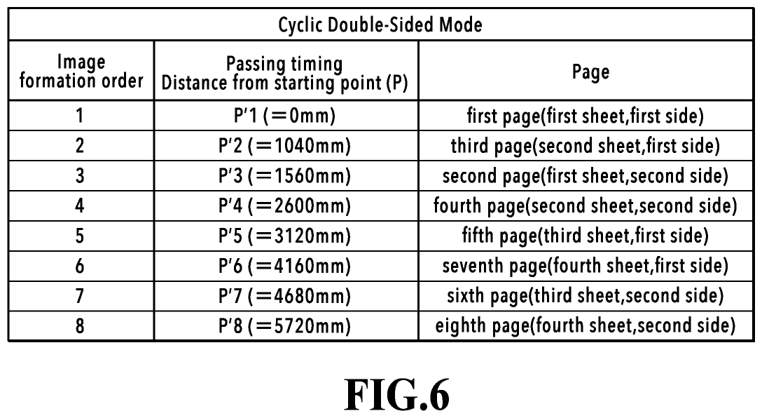

FIG. 5 and FIG. 6 are each an explanatory diagram of the cyclic double-sided mode. FIG. 5 shows the order of pages in a case where the printed sheets are output from the printing module 107. In FIG. 5, black points 301′, 302′, 304′, and 305 each show one example of a spot-shaped defect that occurs in a case where there is an abnormality in the intermediate transfer belt due to the same cause as that in FIG. 3 described above. FIG. 6 is a table putting together relationships between the timing at which the sheet passes the detection sensor 210 and the page to be formed on the sheet after the sheet passes. Details of this table will be described later.

By comparing both tables in FIG. 4 and FIG. 6, it can be seen that the pages whose image formation order is fourth and fifth are different between the alternate double-sided mode and the cyclic double-sided mode. Further, it can also be seen that the page on which the spot-shaped defect occurs, which appears with the same period, is different between the time of the alternate double-sided mode and the time of the cyclic double-sided mode. As described, depending on the operation mode at the time of double-sided printing, the page on which the image defect appears is different, which appears with the same period. The switch between the operation modes at the time of double-sided printing is determined automatically within the system usually without being based on instructions of a user. The determination method of the operation mode will be described later. The image formation orders shown in the tables in FIG. 4 and FIG. 6 are just examples and may change also depending on the configuration of the printing system. In either way, by obtaining and storing information on the image formation order different depending on the operation mode at the time of double-sided printing, it is made possible to accurately determine the periodicity of an image defect.

The printed sheet for which printing in the printing module 107 is completed and which is conveyed up to the connection point 215 is conveyed into the inserter 108. The inserter 108 comprises an inserter tray 221 on which a sheet to be inserted is set. The inserter 108 performs processing to insert the sheet fed from the inserter tray 221 into an arbitrary insertion position in the series of printed sheet groups conveyed from the printing module 107 and convey the series of printed sheet groups to the device in the post stage (inspection module 109). The printed sheet having passed through the inserter 108 is conveyed sequentially to the inspection module 109.

The inspection module 109 comprises image reading units 231 and 232 each having a CIS (Contact Image Sensor) on a conveyance path 233 on which the printed sheet from the inserter 108 is conveyed. The image reading units 231 and 232 are arranged at positions facing each other via the conveyance path 233. The image reading units 231 and 232 are each configured to read the obverse side=front side (first side) and the reverse side=back side (second side) of a sheet at the same time. The image reading unit may be configured by a CCD (Charge Coupled Device) or a line scan camera in place of the CIS.

The inspection module 109 performs defect detection processing to inspect an image formed on a printed sheet that is conveyed through the conveyance path 233. Specifically, the inspection module 109 performs processing to read an image formed on the printed sheet by using the image reading units 231 and 232 at the timing at which the printed sheet currently conveyed reaches a predetermined position. Further, the inspection module 109 inspects whether or not there is a defect in the image formed on the printed sheet based on the read image obtained by the reading processing. The printed sheet having passed through the inspection module 109 is conveyed sequentially to the stacker 110. In the present embodiment, the inspection module 109 detects a print defect by comparing the read image obtained by reading the printed sheet and the reference image registered in advance. As general inspection items, there are deviation of the printed position of an image, tint of an image, density of an image, streak or thin spot having occurred in an image, print omission and the like. As the image comparison method in the defect detection processing, for example, there are a method of comparing pixel values of each pixel and a method of comparing the positions of objects obtained by edge detection. Further, there is also a method in which character data extracted by performing OCR (Optical Character Recognition) for a read image is used.

The stacker 110 comprises a stack tray 241 as a tray onto which a printed sheet is stacked, which is conveyed from the inspection module 109 arranged on the upstream side in the conveyance direction of the printed sheet. The printed sheet having passed through the inspection module 109 is conveyed on a conveyance path 244 within the stacker 110. By the printed sheet conveyed on the conveyance path 244 being guided to a conveyance path 245, the printed sheet is stacked onto the stack tray 241.

The stacker 110 further comprises an escape tray 246 as a discharge tray. In the present embodiment, the escape tray 246 is used for discharging a printed sheet in which a defect is detected by the inspection of the inspection module 109. The printed sheet that is conveyed without being stacked or discharged in the stacker 110 is conveyed to the finisher 111 in the subsequent stage through a conveyance path 248.

The stacker 110 further comprises a reversing unit 249 for reversing the orientation of the printed sheet that is conveyed. The reversing unit 249 is used, for example, for making the same the orientation of the sheet input to the stacker 110 and the orientation of the printed sheet in a case where the printed sheet is stacked onto the stack tray 241 and output from the stacker 110. For the printed sheet that is conveyed to the finisher 111 without being stacked in the stacker 110, the reversing operation by the reversing unit 249 is not performed.

The finisher 111 performs the finishing function designated by a user for the printed sheet that is conveyed from the inspection module 109 arranged on the upstream side in the conveyance direction of the printed sheet. In the present embodiment, the finisher 111 has the finishing function, such as the stapling function (one-portion or two-portion stapling), the punching function (two-hole or three-hole punching), and the saddle stich bookbinding. The finisher 111 comprises two discharge trays 251 and 252. In a case where the finishing processing by the finisher 111 is not performed, the printed sheet conveyed to the finisher 111 is discharged onto the discharge tray 251 through a conveyance path 253. In a case where the finishing processing such as the stapling processing is performed by the finisher 111, the printed sheet conveyed to the finisher 111 is guided to a conveyance path 254. The finisher 111 performs the finishing processing designated by a user for the printed sheet that is conveyed on the conveyance path 254 by using a processing unit 255 and discharges the printed sheet for which the finishing processing has been performed onto the discharge tray 252.

### <Hardware Configuration>

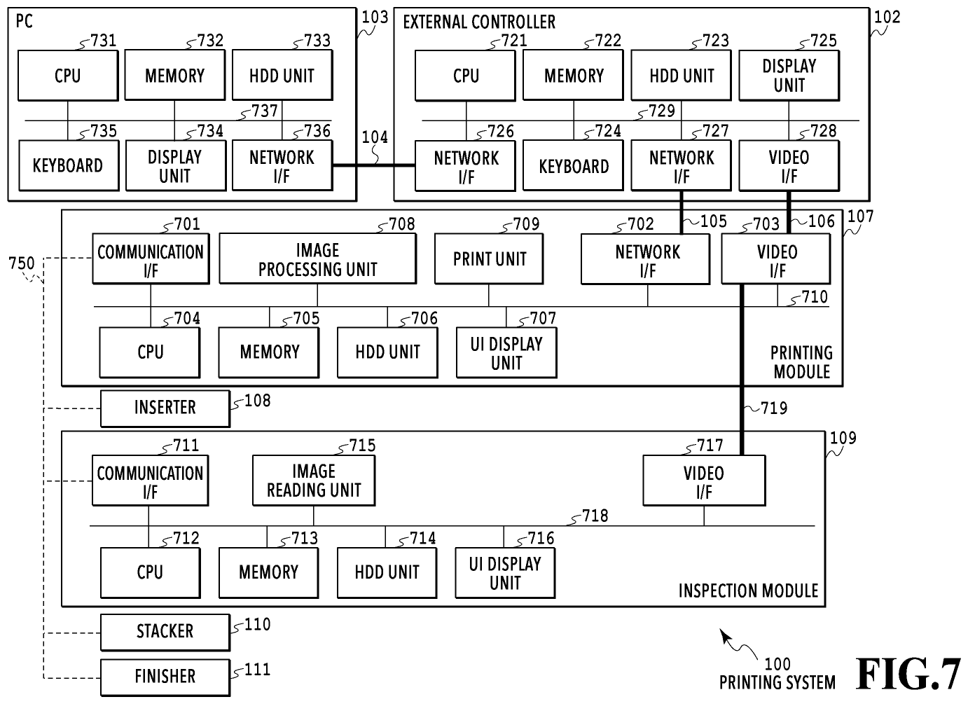

FIG. 7 is a block diagram showing the hardware configuration of the printing apparatus 101, the external controller 102, and the client PC 103. The printing module 107 of the printing apparatus 101 comprises a communication I/F (interface) 701, a network I/F 702, a video I/F 703, a CPU 704, a memory 705, an HDD unit 706, and a UI display unit 707 (261). The printing module 107 further comprises an image processing unit 708 and a printing unit 709. Each of these devices is connected so as to be capable of performing transmission and reception of data with one another via a system bus 710.

The communication I/F 701 is connected with the inserter 108, the inspection module 109, the stacker 110, and the finisher 111 via a communication cable 750. The CPU 704 performs communication for controlling each device via the communication I/F 701. The network I/F 702 is connected with the external controller 102 via the internal LAN 105 and used for communication of control data and the like. The video I/F 703 is connected with the external controller 102 via the video cable 106 and connected with the inspection module 109 via a video cable 719 and used for communication of image data and the like. The printing module 107 (printing apparatus 101) and the external controller 102 may be connected by the video cable 106 alone as long as it is possible for the external controller 102 to control the operation of the printing apparatus 101.

In the HDD unit 706, various programs or data is stored. The CPU 704 controls the operation of the whole printing module 107 by executing programs stored in the HDD unit 706. In the memory 705, programs and data necessary in a case where the CPU 704 performs various types of processing are stored. The memory 705 operates as a work area of the CPU 704. The UI display unit 707 (261) receives instructions to input various settings and to perform operations from a user and is used for displaying various types of information, such as setting information and the processing situation of a print job.

The inserter 108 controls the insertion of a sheet fed from the sheet feeding unit and the conveyance of a sheet conveyed from the printing module 107.

The inspection module 109 comprises a communication I/F 711, a CPU 712, a memory 713, an HDD unit 714, an image reading unit 715 (231 and 232), a UI display unit 716 (262), and a video I/F 717. These devices are connected so as to be capable of performing transmission and reception of data with one another via a system bus 718. The communication I/F 711 is connected with the printing module 107 via the communication cable 750. The CPU 712 performs communication necessary for control of the inspection module 109 via the communication I/F 711. The CPU 712 controls the operation of the inspection module 109 by executing a control program stored in the memory 713. In the memory 713, a control program for the inspection module 109 is stored. The video I/F 717 is connected with the printing module 107 via the video cable 719 and used for communication of data, such as image data.

The image reading unit 715 (231 and 232) reads an image formed on a conveyed printed sheet in accordance with instructions of the CPU 712. The CPU 712 inspects whether or not there is a defect in the image formed on the printed sheet by comparing the read image (inspection image) obtained by the image reading unit 715 with the reference image. The reference image of the present embodiment is a bitmap image obtained by rasterizing the PDL data used for the print processing. However, it may also be possible to read a sample sheet by the image reading unit 715, in which an operator has checked that there is no defect by visual recognition, and take the obtained read image as the reference image.

The UI display unit 716 (262) is used to display inspection results, setting screens and the like. The operation unit is also used as the UI display unit 716 and operated by a user, and for example, receives various instructions from a user, such as instructions to change the setting of the inspection module 109, instructions to register the reference image, and instructions to perform image diagnosis. In the HDD unit 714, various types of setting information and image data necessary for inspection are stored. It is possible to reuse the various types of setting information and image data stored in the HDD unit 714.

The stacker 110 performs control to discharge the printed sheet conveyed through the conveyance path onto the stack tray or the escape tray, or convey the printed sheet to the finisher 111 connected on the downstream side in the conveyance direction of the printed sheet.

The finisher 111 controls the conveyance and discharge of a printed sheet and performs the finishing processing, such as stapling, punching, or saddle stich bookbinding.

The external controller 102 comprises a CPU 721, a memory 722, an HDD unit 723, a keyboard 724, a display unit 725, network I/Fs 726 and 727, and a video I/F 728. These devices are connected so as to be capable of performing transmission and reception of data with one another via a system bus 729. The CPU 721 controls the operation of the whole external controller 102, for example, such as reception of print data from the client PC 103, RIP processing, and transmission of a print job to the printing apparatus 101, by executing programs stored in the HDD unit 723. In the memory 722 programs and data necessary in a case where the CPU 721 performs various types of processing are stored. The memory 722 operates as a work area of the CPU 721.

In the HDD unit 723, various programs and data are stored. The keyboard 724 is used by a user to input instructions to operate the external controller 102. The display unit 725 is, for example, a display and used to display information on an application currently executed in the external controller 102 and the operation screen. The network I/F 726 is connected with the client PC 103 via the external LAN 104 and used for communication of data, such as printing instructions. The network I/F 727 is connected with the printing apparatus 101 via the internal LAN 105 and used for communication of data, such as printing instructions. The external controller 102 is configured so as to be capable of communicating with the printing module 107, the inserter 108, the inspection module 109, the stacker 110, and the finisher 111 via the internal LAN 105 and the communication cable 750. The video I/F 728 is connected with the printing apparatus 101 via the video cable 106 and used for communication of data, such as a print job.

The client PC 103 comprises a CPU 731, a memory 732, an HDD unit 733, a display unit 734, a keyboard 735, and a network I/F 736. These devices are connected so as to be capable of performing transmission and reception of data with one another via a system bus 737. The CPU 731 controls the operation of each device via the system bus 737 by executing programs stored in the HDD unit 733. Due to this, various pieces of processing by the client PC 103 are implemented. For example, the CPU 731 generates print data and gives printing instructions by executing a document processing program stored in the HDD unit 733. In the memory 732, programs and data necessary in a case where the CPU 731 performs various pieces of processing are stored. The memory 732 operates as a work area of the CPU 731.

In the HDD unit 733, for example, various applications such as the document processing program, programs such as a printer driver, and various pieces of data are stored. The display unit 734 is, for example, a display and used to display information on an application currently executed in the client PC 103, and the operation screen. The keyboard 735 is used by a user to input instructions to operate the client PC 103. The network I/F 736 is connected with the external controller 102 via the external LAN 104 so as to be capable of communication. The CPU 731 communicates with the external controller 102 via the network I/F 736.

In the configuration example in FIG. 1, the external controller 102 is connected to the printing apparatus 101, but it is also possible to apply the present embodiment to a configuration different from this configuration. For example, a configuration may be used in which the printing apparatus 101 is connected to the external LAN 104 and print data is transmitted from the client PC 103 to the printing apparatus 101 without the intervention of the external controller 102. In this case, data analysis, interpretation, and rasterization for print data are performed by the printing apparatus 101.

### <Operation Flow of Printing Apparatus>

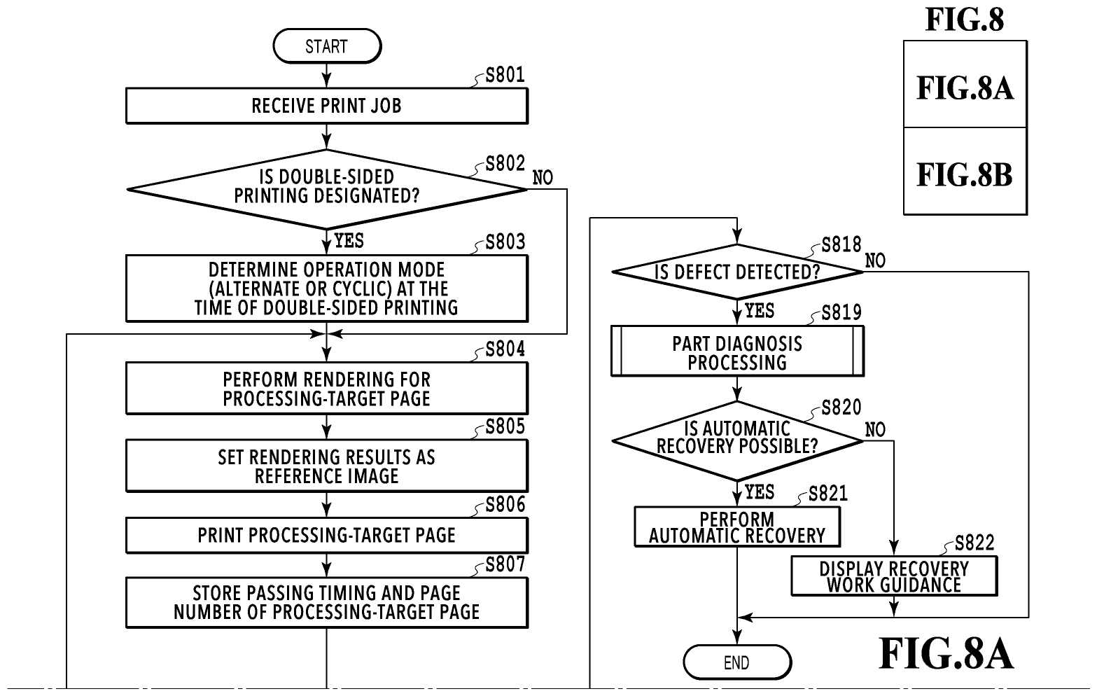

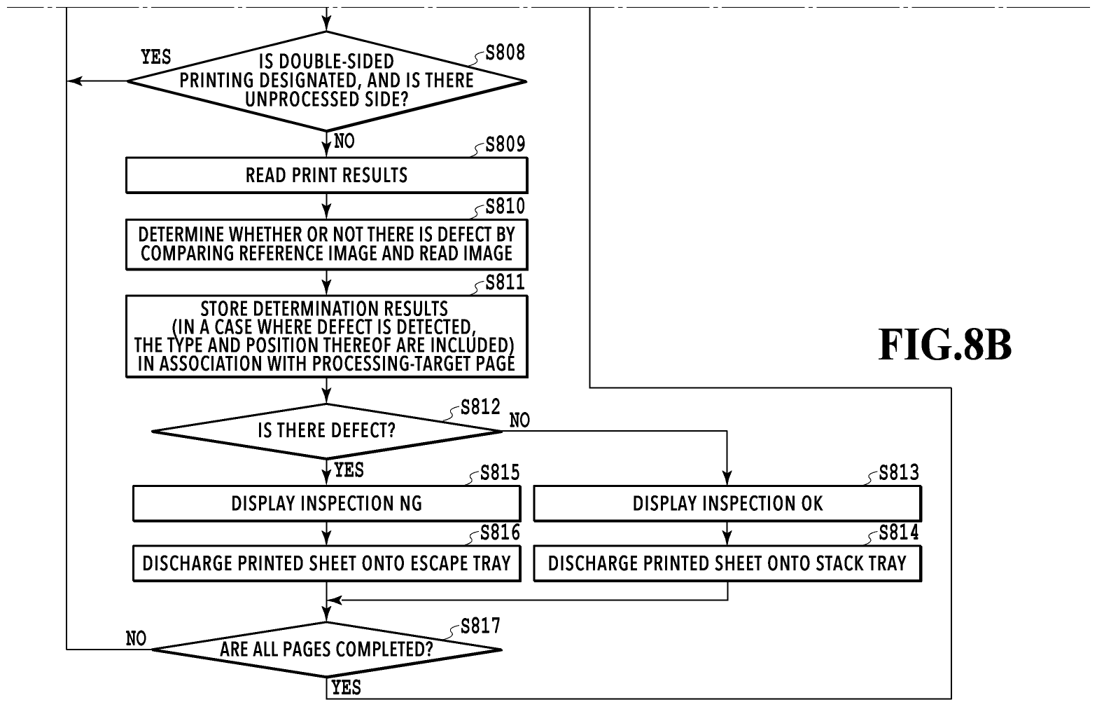

Following the above, the operation flow of the printing apparatus 101 according to the present embodiment is explained by using the flowcharts in FIGS. 8A and 8B. In the series of processing shown by the flowcharts in FIGS. 8A and 8B, three pieces of processing are included: print processing based on a print job; defect detection processing for a printed sheet; and part diagnosis processing to be performed in a case where a defect is detected. The print processing is performed in the printing module 107 and the defect detection processing and the part diagnosis processing are performed in the inspection module 109. In the following, detailed explanation is given along the flowcharts in FIGS. 8A and 8B. In the following explanation, a symbol “S” means a step.

At S801, the print job transmitted from the external controller 102 is received by the printing module 107.

At S802, in the printing module 107, whether double-sided printing is designated is determined by referring to the printing setting information included in the print job received at S801. In a case where double-sided printing is designated, S803 is performed next. In a case where double-sided printing is not designated, the S803 is skipped and S804 is performed next.

At S803, in the printing module 107, the operation mode in a case where double-sided printing is performed is determined automatically. In double-sided printing, there is a case where scaling processing is necessary, which adjusts the magnification of a formation-target image for the first side (for example, the obverse side) and the second side (for example, the reverse side) because the sheet contracts due to heat at the time of fixing and it is not possible to perform printing appropriately as it is because of deformation of the object within the image. Consequently, before the start of double-sided printing, whether it is necessary to perform the scaling adjustment such as this is determined based on the sheet type designated in the printing setting information and the like and in a case where the scaling adjustment is necessary, the cyclic double-sided mode is determined in which it is possible to secure time for scaling processing although the throughput is reduced relatively. On the other hand, in a case where scaling adjustment is not necessary, priority is given to throughput and the alternate double-sided mode is determined.

At S804, in the printing module 107, the processing-target page is determined first among all the processing-target pages designated in the print job. Then, rendering processing is performed based on the PDL data of the determined processing-target page and a bitmap image of the processing-target page is generated. The data of the generated bitmap image is sent to the inspection module 109 via the video I/F 703 as well as being stored in the memory 705.

At S805, in the inspection module 109, the bitmap image obtained at S804 is set as the reference image for defect detection as well as the data of the bitmap image is stored in the memory 713.

At S806, in the printing module 107, print processing using the bitmap image, which is the results of the rendering of the processing-target page, is performed by the printing unit 709. At this time, the timing at which the sheet on which the bitmap image of the processing-target page is formed passes the detection sensor 210 is obtained. Here, the passing timing of the processing-target page is represented by the distance from a reference position P1, which is the end (front end or rear end) of the sheet in a case where the sheet of the first page passes. P1 at the passing timing of the sheet on which the first processing-target page is formed is taken as the starting point (=0 mm) and after this, in order in which image formation is performed, a distance Pn from the starting point P1 is obtained for each page. For example, in a case where the processing-target page is the page for which image formation is performed second, a distance P2 indicating the passing timing of the sheet on which the image formation is performed is the distance from P1 at the point in time at which the end of the sheet passes. Similarly, in a case where the processing-target page is the page for which image formation is performed third, a distance P indicating the passing timing of the sheet on which the image formation is performed is the distance from P1 at the point in time at which the end of the sheet passes. In the following, for convenience of explanation, distances indicating the passing timing in a case of the alternate double-sided printing are described as P1, P2, P3, . . . , and distances indicating the passing timing in a case of the cyclic double-sided printing are described as P′1, P′2, P′3, . . . . The distance Pn (Pn′) indicating the passing timing thus obtained is sent to the inspection module 109 as passing timing information along with the page number of the processing-target page and information indicating what number sheet the sheet on which the processing-target page is formed is.

At S807, in the inspection module 109, the passing timing information on the processing-target page is stored, which is received from the printing module 107. Specifically, in the “Passing timing” field and the “Page” field of the table in FIG. 4 and FIG. 6 described previously, the distance from the starting point P1 indicated by the passing timing and the page number of the processing-target page are associated with each other and stored in order in which image formation is performed as follows. Here, it is assumed that the size of the sheet used for printing is A3 (297 mm×420 mm) and the sheet interval at the time of conveyance is 100 mm.

### <<In a Case of Alternative Double-Sided Mode>>

As shown in FIG. 4, in a case where the first image formation is performed, in the row of “1” of Image formation order, “P1 (=0 mm)” and “first page (first sheet, first side)” are stored respectively. Then, in a case where the second image formation is performed, in the row of “2” of Image formation order, “P2 (=1040 mm)” and “third page (second sheet, first side)” are stored respectively. After this, the same processing is repeated. That is, in a case where the third image formation is performed, in the row of “3” of Image formation order, “P3 (=1560 mm)” and “second page (first sheet, second side)” are stored. In a case where the fourth image formation is performed, in the row of “4” of Image formation order, “P4 (=2080 mm)” and “fifth page (third sheet, first side)” are stored. In a case where the fifth image formation is performed, in the row of “5” of Image formation order, “P5 (=2600 mm)” and “fourth page (second sheet, second side)” are stored. In a case where the sixth image formation is performed, in the row of “6” of Image formation order, “P6 (=3120 mm)” and “seventh page (fourth sheet, first side)” are stored. In a case where the seventh image formation is performed, in the row of “7” of Image formation order, “P7 (=3640 mm)” and “sixth page (third sheet, second side)” are stored. In a case where the eighth image formation is performed, in the row of “8” of Image formation order, “P8 (=4680 mm)” and “eighth page (fourth sheet, second side)” are stored.

### <<In a Case of Cyclic Double-Sided Mode>>

As shown in FIG. 6, in a case where the first image formation is performed, in the row of “1” of Image formation order, “P′1 (=0 mm)” and “first page (first sheet, first side)” are stored respectively. Then, in a case where the next (second) image formation is performed, in the row of “2” of Image formation order, “P′2 (=1040 mm)” and “third page (second sheet, first side)” are stored respectively. After this, the same processing is repeated. That is, in a case where the third image formation is performed, in the row of “3” of Image formation order, “P′3 (=1560 mm)” and “second page (first sheet, second side)” are stored. In a case where the fourth image formation is performed, in the row of “4” of Image formation order, “P′4 (=2600 mm)” and “fourth page (second sheet, second side)” are stored. In a case where the fifth image formation is performed, in the row of “5” of Image formation order, “P′5 (=3120 mm)” and “fifth page (third sheet, first side)” are stored. In a case where the sixth image formation is performed, in the row of “6” of Image formation order, “P′6 (=4160 mm)” and “seventh page (fourth sheet, first side)” are stored. In a case where the seventh image formation is performed, in the row of “7” of Image formation order, “P′7 (=4680 mm)” and “sixth page (third sheet, second side)” are stored. In a case where the eighth image formation is performed, in the row of “8” of Image formation order, “P′8 (=5720 mm)” and “eighth page (fourth sheet, second side)” are stored.

Here, for example, in a case where attention is paid on the fourth in Image formation order, it can be seen that while the image formation of the fifth page is performed in the alternate double-sided mode (see FIG. 4), in the cyclic double-sided mode, the image formation of the fourth page is performed (see FIG. 6). As described above, the processing order of pages (image formation order) is different between the alternate double-sided mode and the cyclic double-sided mode, and therefore, it becomes necessary to figure out ways and means to correctly grasp periodicity in a case where an image defect occurs.

At S808, whether double-sided printing is designated in the print job and there is an unprocessed side for which the image formation is not performed yet on the target sheet is determined. In a case where double-sided printing is designated and there is an unprocessed side, the processing returns to S804, and the next processing-target page is determined and the processing is continued. On the other hand, in a case where double-sided printing is not designated or in a case where double-sided printing is designated and the image formation for both the obverse side and the reverse side of the target sheet is completed, S809 is performed next.

At S809, in the inspection module 109, the printed sheet conveyed from the printing module 107 is read. At this time, in a case where double-sided printing is designated, reading is performed for both the obverse side and the reverse side of the printed sheet. The data of the read image obtained by the reading processing is stored in the memory 713.

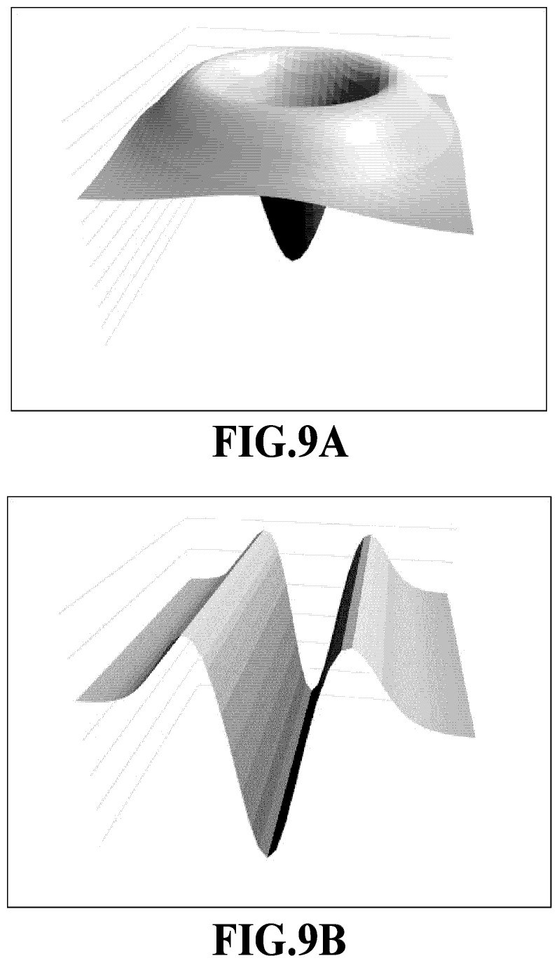

At S810, in the inspection module 109, the read image obtained at S809 and the corresponding reference image set at S805 are compared and whether there is an image defect is inspected (defect detection processing). In a case of the comparison, various pieces of image processing are performed as needed, such as filtering and resolution conversion for the read image, and transformation correction (position adjustment) for the reference image. The determination of whether there is an image defect is performed by the procedure as follows. First, a difference image is generated by extracting the difference between the reference image and the read image and filter processing for emphasizing a specific shape is performed for the difference image. FIG. 9A is one example of a filer for emphasizing a spot-shaped defect and FIG. 9B is one example of a filter for emphasizing a linear defect. For the difference image for which emphasizing processing using these filters has been performed, binarization processing is performed, which allocates “1” in a case where the difference value exceeds a threshold value and “0” in a case where the difference value is less than or equal to the threshold value. Then, in the binary image obtained by the binarization processing, in a case where the pixel whose difference value exceeds the threshold value and to which “1” is allocated does not exist, “normal” is determined and in a case where the pixel such as described above exists, it is determined that there is a defect. The method of the defect detection described here is one example and the method is not limited to this and it is possible for a user to perform a method capable of detecting a defect the user desires to detect.

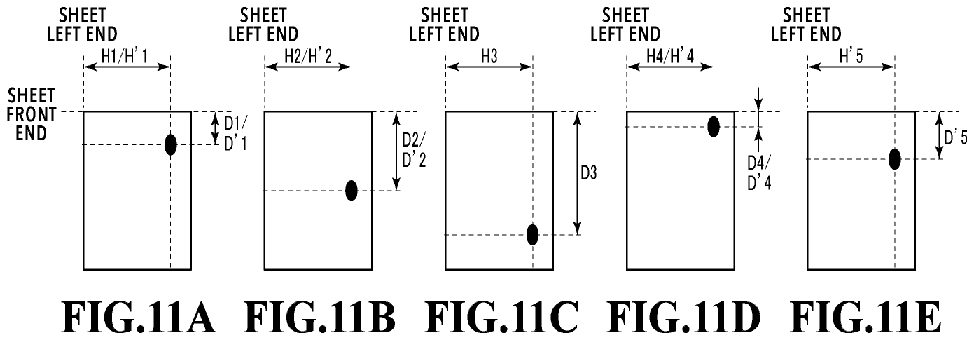

At S811, in the inspection module 109, the results of the inspection at S810 are stored in the memory 713 in association with the page of the image formed on the printed sheet. At this time, in a case where some defect is detected, information on the type of the detected defect (for example, spot-shaped defect or steak) and the position (coordinates representing the position within the page) is also stored. FIG. 11A to FIG. 11E are each a diagram showing the position of the spot-shaped defect detected in each page in the case in FIG. 3 and FIG. 5 described previously. The position of the spot-shaped defect detected from each page is identified by a position D in the sheet conveyance direction, which corresponds to a distance D from the front end of the sheet, and a position H in the sheet width direction, which corresponds to a distance from the leftmost end of the sheet. FIG. 11A shows a position (D1/D′1, H1/H′1) of a spot-shaped defect 301/301′ detected from the first page in FIG. 3 and FIG. 5 and the position is stored in association with a processing-target page 1 as information on the detection position of “spot-shaped defect”. Similarly, FIG. 11B shows a position (D2/D′2, H2/H′2) of a spot-shaped defect 302/302′ detected from the third page in FIG. 3 and FIG. 5 and the position is stored in association with a processing-target page 2 as information on the detection position of “spot-shaped defect”. FIG. 11C shows a position (D3, H3) of a spot-shaped defect 303 detected from the fifth page in FIG. 3 and the position is stored in association with a processing-target page 5 as information on the detection position of “spot-shaped defect”. FIG. 11D shows a position (D4/D′4, H4/H′4) of a spot-shaped defect 304/304′ detected from the eighth page in FIG. 3 and detected from the sixth page in FIG. 5. Each position is stored in association with each page as information on the detection position of “spot-shaped defect”. FIG. 11E shows a position (D′5, H′5) of a spot-shaped defect 305 detected from the eighth page in FIG. 5 and the position is stored in association with a processing-target page 8 as information on the detection position of “spot-shaped defect”. In a case where the detected defect is, for example, “streak”, it is sufficient to identify the position D in the sheet conveyance direction and the position H in the sheet width direction respectively by taking the position at which the density takes the maximum density as a reference from profile data indicating the density distribution of the streak portion.

At S812, in the inspection module 109, based on the results of the inspection at S810, the next processing is allocated. That is, in a case where no defect is detected, the display processing at S813 is performed and in a case where a defect is detected, the display processing at S815 is performed.

At S813 in a case where no defect is detected, in the inspection module 109, a message such as “inspection OK” indicating that no defect is detected is displayed on the UI display unit 716. Then, at S814, the printing module 107 is instructed to discharge the printed sheet on which the processing-target page is printed onto the stack tray 241 of the stacker 110. Then, based on the instructions from the inspection module 109, the printing module 107 instructs the stacker 110 to discharge the printed sheet on which the processing-target page is printed onto the stack tray 241.

On the other hand, at S815 in a case where a defect is detected, in the inspection module 109, a message such as “inspection NG” indicating that a defect is detected is displayed on the UI display unit 262 (716). Then, at S816, the printing module 107 is instructed to discharge the printed sheet on which the processing-target page is printed onto the escape tray 246 of the stacker 110. Then, based on the instructions from the inspection module 109, the printing module 107 instructs the stacker 110 to discharge the printed sheet on which the processing-target page is printed onto the escape tray 246.

At S817, in the printing module 107, whether or not the printing and inspection of all the pages designated in the print job are completed is determined. In a case where the printing and inspection are not completed for all the pages, the processing returns to S804, and the next processing-target page is determined and the same processing is repeated. On the other hand, in a case where the printing and inspection are completed for all the pages, allocation processing at S818 is performed next.

At S818, in the inspection module 109, for the print job for which the printing and inspection of all the pages are completed, whether or not a defect has been detected is determined. In a case where a defect has not been detected, the present processing is terminated. On the other hand, in a case where a defect has been detected, part diagnosis processing at S819 is performed next. Here, the part diagnosis processing is processing to identify a trouble portion in the printing module 107 based on the presence/absence of periodicity of a defect detected from the plurality of printed sheets output successively. Details of the part diagnosis processing will be described later.

At S820, in the inspection module 109, whether automatic recovery is possible is determined based on the results of the part diagnosis processing. In a case where the automatic recovery is determined to be possible, at S821, automatic recovery processing is performed and in a case where the automatic recovery is determined to be not possible, at S822, processing to display a recovery work guidance is performed.

At S821 in a case where the automatic recovery is determined to be possible, in the printing module 107, the automatic recovery processing is performed. As a treatment in a case where the automatic recovery is possible, for example, there is cleaning of the wire and grid of the charging unit (corona charger) of the photoconductor drum comprised in the image formation stations 204 to 207, or the like.

On the other hand, at S822 in a case the automatic recovery is determined to be not possible, in the printing module 107 and/or the inspection module 109, part diagnosis results and a recovery work guidance indicating a necessary treatment method are displayed on the UI display unit 261/262. As a treatment in a case where the automatic recovery is not possible, for example, there are wiping off the stains on the reading surface of the image reading units 231 and 232 of the inspection module 109, removing fiber and foreign matter sticking to the sheet, and a treatment requiring user work such as adjustment of the sheet. Alternatively, there is a treatment requiring maintenance work by a service person, such as exchange of parts. The above is the operation flow of the printing apparatus 101.

### <Details of Part Diagnosis Processing>

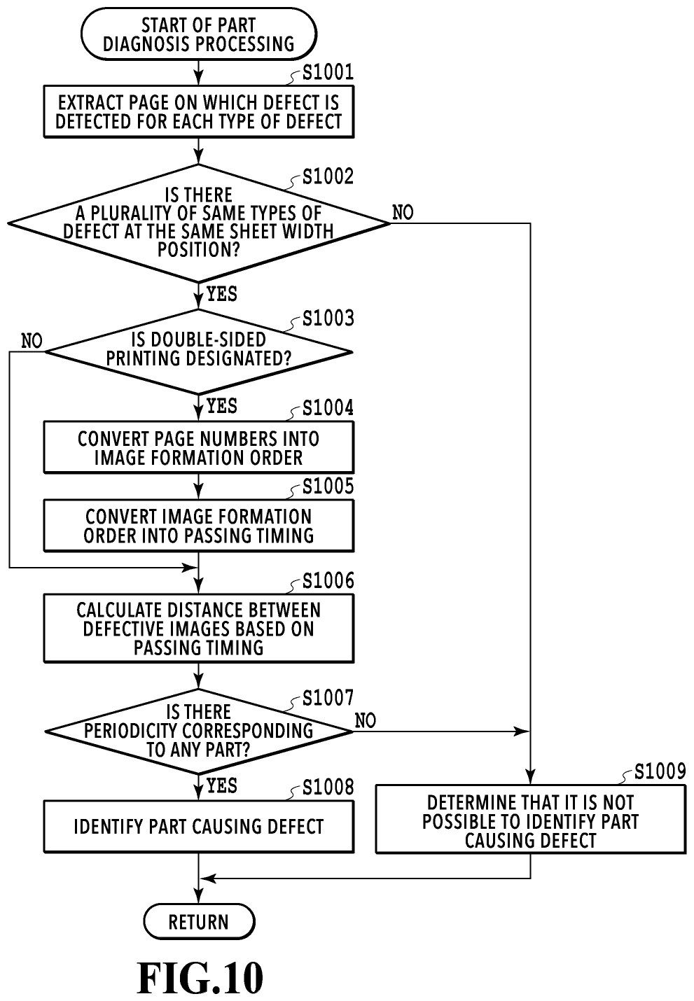

Following the above, the part diagnosis processing (S819) that is performed in a case where a defect is detected is explained in detail with reference to the flowchart in FIG. 10.

At S1001, processing to extract the page on which a defect is detected for each type of defect from the inspection results is performed. As described previously, as the types of defect, for example, there are “spot-shaped defect”, “streak” meaning a linear defect, and the like. For example, in the example in FIG. 3 described previously in a case of the alternate double-sided mode, for the type of defect “spot-shaped defect”, four pages, that is, the first page, the third page, the fifth page, and the eighth page are extracted. Further, in the example in FIG. 5 described previously in a case of the cyclic double-sided mode, for the type of defect “spot-shaped defect”, four pages, that is, the first page, the third page, the sixth page, and the eight pages are extracted.

At S1002, whether a plurality of the same types of defect exists at the same sheet width position (the position whose distance from the leftmost end of the sheet in the width direction is the same) is determined. In a case where a plurality of the same types of defect exists, S1003 is performed next and in a case where a plurality of the same types of defect does not exist, S1009 is performed next. Here, it is assumed that in the examples in FIG. 3 and FIG. 5 described previously, the same type of defect “spot-shaped defect” is detected at the same sheet width position on all the extracted pages. Consequently, in this case, the processing advances to S1003.

At S1003, whether double-sided printing is designated in the performed print job is determined. In a case where double-sided printing is designated, S1004 and S1005 are performed next. The processing at S1004 and S1005 is processing for achieving consistency between the image formation order of each page according to the print job and the reading order in accordance with the operation mode in a case where double-sided printing is performed. On the other hand, in a case where double-sided printing is not designated, S1006 is performed next.

At S1004, processing to convert the page numbers of all the pages extracted at S1001 into the image formation order is performed for the plurality of the same types of defect detected at the same sheet width position. This conversion is performed with reference to the table obtained at S807 in the flow in FIG. 8A described previously. Then, in the double-sided printing, the order of image formation is different in accordance with the operation mode thereof, and therefore, in the examples in FIG. 3 and FIG. 5 described previously, conversion is performed as follows, respectively.

### <<In a Case of Alternate Double-Sided Mode (Example in FIG. 3)>>

first page: formation order first
third page: formation order second
fifth page: formation order fourth
eighth page: formation order eighth

### <<In a Case of Cyclic Double-Sided Mode (Example in FIG. 5)>>

first page: formation order first
third page: formation order second
sixth page: formation order seventh
eighth page: formation order eighth

At S1005, processing to convert the image formation order obtained at S1003 into passing timing is performed. This conversion is performed also with reference to the table obtained at S807 in the flow in FIG. 8A described previously. In the examples in FIG. 3 and FIG. 5 described previously, conversion is performed as follows respectively.

### <<In a Case of Alternate Double-Sided Mode (Example in FIG. 3)>>

formation order first: passing timing P1
formation order second: passing timing P2
formation order fourth: passing timing P4
formation order eighth: passing timing P8

### <<In a Case of Cyclic Double-Sided Mode (Example in FIG. 5)>>

formation order first: passing timing P′1
formation order second: passing timing P′2
formation order seventh: passing timing P′7
formation order eighth: passing timing P′8

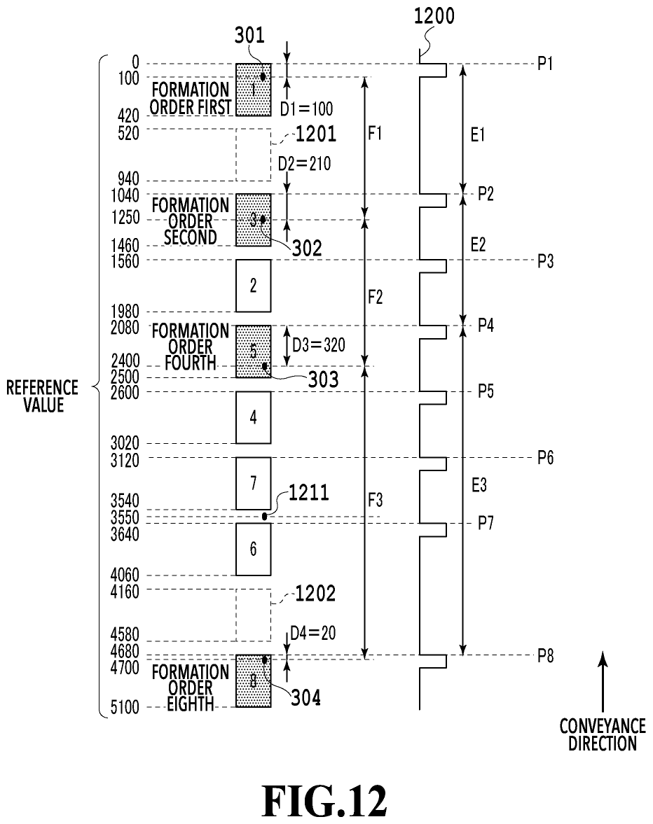

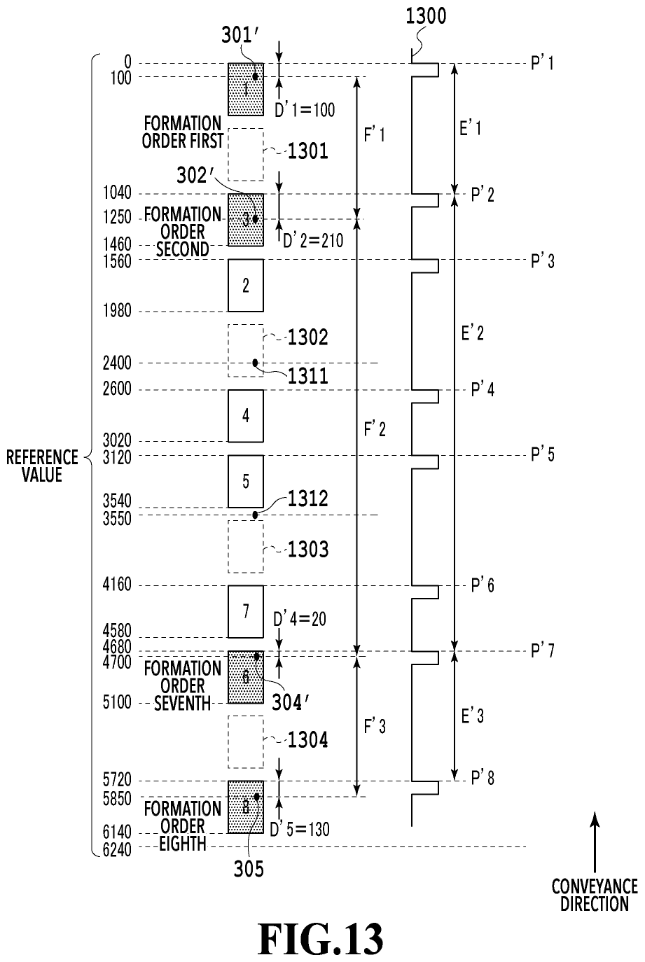

At S1006, processing to calculate the distance between the read images in which a defect is detected from the passing timing information on each page. In the following, an image in which a defect is detected is described as “defective image”. FIG. 12 is a diagram showing a relationship between the image formation order and the passing timing in the example in FIG. 3 in the alternate double-sided mode and FIG. 13 is a diagram showing a relationship between the image formation order and the passing timing in the example in FIG. 5 in the cyclic double-sided mode. In the following, the distance between defective images, which is calculated in each example, is explained. As described above, it is assumed that the size of the sheet used for printing is A3 (297 mm×420 mm) and the sheet interval at the time of conveyance is 100 mm.

### <<In a Case of Alternate Double-Sided Mode (Example in FIG. 3)>>

In FIG. 12, the distance D1 (see FIG. 11A) is found as the distance from the front end of the sheet and is 100 mm. Further, the distance D2 (see FIG. 11B) is found as the distance from the front end of the sheet and is 210 mm. Further, the distance D3 (see FIG. 11C) is found as the distance from the front end of the sheet and is 320 mm. Further, the distance D4 (see FIG. 11D) is found as the distance from the front end of the sheet and is 20 mm.

In FIG. 12, a pulsed line 1200 indicates an output signal of the detection sensor 210. Then, in FIG. 12, a two-directional arrow E1 indicates the conveyance interval from the front end of the sheet whose formation order is first to the front end of the sheet whose formation order is second. Similarly, a two-directional arrow E2 indicates the conveyance interval from the front end of the sheet whose formation order is second to the front end of the sheet whose formation order is fourth. Similarly, a two-directional arrow E3 indicates the conveyance interval from the front end of the sheet whose formation order is fourth to the front end of the sheet whose formation order is eighth. Further, in FIG. 12, broken-line frames 1201 and 1202 indicate a blank page (section in which no sheet exists) for which image formation is not performed.

As is obvious from FIG. 12, it is possible to find a distance F1 between defective images, that is, between the spot-shaped defect 301 and the spot-shaped defect 302 in the conveyance direction by calculation as follows.

$$E 1 = P 2 - P 1 = 1 , 040 - 0 = 1 , 040 \\ F 1 = E 1 - D 1 + D 2 = 1 , 040 - 100 + 210 = 1 , 150 mm$$

It is possible to find a distance F2 between defective images, that is, between the spot-shaped defect 302 and the spot-shaped defect 303 in the conveyance direction by calculation as follows.

$$E 2 = P 4 - P 2 = 2 , 080 - 1 , 040 = 1 , 040 \\ F 2 = E 2 - D 2 + D 3 = 1 , 040 - 210 + 320 = 1 , 150 mm$$

It is possible to find a distance F3 between defective images, that is, between the spot-shaped defect 303 and the spot-shaped defect 304 in the conveyance direction by calculation as follows.

$$E 3 = P 8 - P 4 = 4 , 680 - 2 , 080 = 2 , 600 \\ F 3 = E 3 - D 3 + D 4 = 2 , 600 - 320 + 20 = 2 , 300 mm ( 1 , 150 \times 2 )$$

From the above, it can be seen that each distance between defective images is N times 1,150.

A black circle 1211 located at the position 3,550 mm from the starting point indicates a spot-shaped defect located at a position between sheets at the time of conveyance and which would appear in printing in a case where a sheet exists. Further, it is needless to say that the above-described numerical values are each an ideal value and in reality, the numerical value is found from the output value of the detection sensor 210, and therefore, the value is different from the ideal value.

### <<In a Case of Cyclic Double-Sided Mode (Example in FIG. 5)>>

In FIG. 13, the distance D′1 (see FIG. 11A) is found as the distance from the front end of the sheet and is 100 mm. Further, the distance D′2 (see FIG. 11B) is found as the distance from the front end of the sheet and is 210 mm. Further, the distance D′4 (see FIG. 11D) is found as the distance from the front end of the sheet and is 20 mm. Further, the distance D′5 (see FIG. 11E) is found as the distance from the front end of the sheet and is 130 mm.

In FIG. 13, a pulsed line 1300 indicates an output signal of the detection sensor 210. Then, in FIG. 13, a two-directional arrow E′1 indicates the conveyance interval from the front end of the sheet whose formation order is first to the front end of the sheet whose formation order is second. Similarly, a two-directional arrow E′2 indicates the conveyance interval from the front end of the sheet whose formation order is second to the front end of the sheet whose formation order is seventh. Similarly, a two-directional arrow E′3 indicates the conveyance interval from the front end of the sheet whose formation order is seventh to the front end of the sheet whose formation order is eighth.

As is obvious from FIG. 13, it is possible to find a distance F′1 between defective images, that is, between the spot-shaped defect 301′ and the spot-shaped defect 302′ in the conveyance direction by calculation as follows.

$${E}^{′} 1 = {P}^{′} 2 - {P}^{′} 1 = 1 , 040 - 0 = 1 , 040 \\ {F}^{′} 1 = {E}^{′} 1 - {D}^{′} 1 + {D}^{′} 2 = 1 , 040 - 100 + 210 = 1 , 150 mm$$

It is possible to find a distance F′2 between defective images, that is, between the spot-shaped defect 302′ and the spot-shaped defect 304′ in the conveyance direction by calculation as follows.

$${E}^{′} 2 = {P}^{′} 7 - {P}^{′} 2 = 4 , 680 - 1 , 040 = 3 , 640 \\ {F}^{′} 2 = {E}^{′} 2 - {D}^{′} 2 + {D}^{′} 4 = 3 , 640 - 210 + 20 = 3 , 450 mm ( 1 , 150 \times 3 )$$

It is possible to find a distance F′3 between defective images, that is, between the spot-shaped defect 304′ and the spot-shaped defect 305′ in the conveyance direction by calculation as follows.

$${E}^{′} 3 = {P}^{′} 8 - {P}^{′} 7 = 5 , 720 - 4 , 680 = 1 , 040 \\ {F}^{′} 3 = {E}^{′} 3 - {D}^{′} 4 + {D}^{′} 5 = 1 , 040 - 20 + 130 = 1 , 150 mm$$

From the above, it can be seen that each distance between defective images is N times 1,150. A black circle 1311 located at the position 2,400 mm from the starting point and a black circle 1312 located at the position 3,550 mm from the starting point indicate spot-shaped defects located at positions between sheets at the time of conveyance and which would appear in printing in a case where sheets exist.

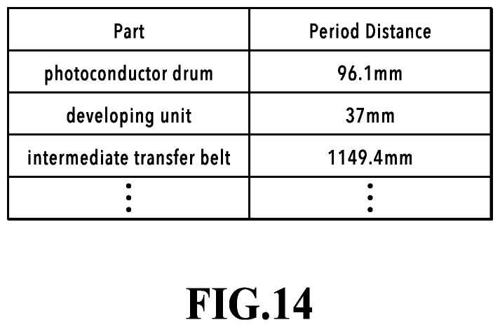

At S1007, based on the distance between defective images calculated at S1006, whether or not there is periodicity of defect corresponding to some part is determined. For this determination, information (part period information) recording the periodicity of each part is used, which is prepared in advance. FIG. 14 is a diagram showing a table as one example of part period information. The part period information shown in FIG. 14 predefines the period distance of each part in the conveyance direction in which a defect occurs. The period distance of each part included in the part period information such as this and the distance between defective images calculated at S1005 are compared and in a case where there is a part having the period distance matching N (N=1, 2, 3, . . . ) times the period, it is determined that there is periodicity. In a case where the difference obtained by a comparison is within a range of threshold value based on the rule of thumb, the period distance is handled as matching N times the period. In a case where it is determined that there is periodicity, S1008 is performed next and in a case where it is determined that there is no periodicity, S1009 is performed next. It may also be possible to determine whether or not there is periodicity by storing in advance information with which it is possible to calculate the period distance in the conveyance direction in which a defect occurs for each part, such as the diameter of each part and the difference in speed from the sheet conveyance speed, as part period information and by finding the period distance of each part by performing calculation each time.

At S1008, the part whose period distance matches N times the period is identified as the part having caused the detected defect. On the other hand, at S1009, it is not possible to identify a part having caused the defect based on the periodicity because the detected defect is accidental, and therefore, it is determined that the part having caused the defect cannot be identified and the present processing is exited.

The above is the contents of the part diagnosis processing. In the present embodiment, each time one print job is processed and a defect is detected, the part diagnosis processing is performed, but in many cases, the image defect, such as the spot-shaped defect and the streak, grows gradually. Consequently, it may also be possible to perform the part diagnosis processing only for a specific print job at a certain interval.

### Modification Example

In the embodiment described above, all the processing is completed within the printing apparatus 101, but for example, it may also be possible to perform the part diagnosis processing on the cloud. In this case, the server apparatus (external apparatus) providing the cloud service receives necessary information (specifically, passing time information on each page, inspection results information on each print job, part period information) from the printing apparatus 101 (or via the external controller 102) and performs the above-described part diagnosis processing. Then, the server apparatus returns the results thereof to the printing apparatus 101. As regards the part period information depending on the model type of the printing apparatus, it may also be possible for the server apparatus to store in advance the part period information on a plurality of model types and receive only information identifying the model type from the printing apparatus and use the corresponding part period information.

As above, according to the present embodiment, even in a case where the order of pages at the time of image formation is different due to the difference in the operation mode at the time of double-sided printing, it is possible to correctly grasp the periodicity of a detected image defect and perform part fault diagnosis with accuracy based on the results thereof.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the technique of the present disclosure, it is possible to correctly grasp the periodicity of an image defect in a case of double-sided printing and diagnose a part fault with accuracy.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-064872, filed Apr. 12, 2023, which is hereby incorporated by reference wherein in its entirety.

What is claimed is:

1. A printing apparatus comprising:
a printing unit configured to perform printing on a printing medium by using color materials, and having a double-sided printing function;
a reading unit configured to generate a read image by reading a printed medium output from the printing unit; and
an inspection unit configured to inspect whether or not there is a defect on the printed medium based on the read image, the printing apparatus further comprising:
one or more memories storing instructions; and
one or more processors executing the instructions to perform:
determining periodicity of a detected defect based on inspection results by the inspection unit for a plurality of the printed printing media output successively, wherein
the double-sided printing function includes two operation modes in which processing order of pages is different and
the periodicity is determined based on results of processing that is in accordance with an operation mode in a case where double-sided printing is performed in the printing unit and which achieves consistency between page order in a case where printing is performed in the printing unit and page order in a case where reading is performed in the reading unit.

2. The printing apparatus according to claim 1, wherein
the determination is performed in a case where a plurality of the same types of defect is detected at the same width position of the printing medium in the inspection.

3. The printing apparatus according to claim 2, wherein
the printing unit comprises a sensor detecting the printing medium and
the one or more processors further execute the instructions to perform:
associating information on timing at which a printing medium on which an image of a processing-target page is formed passes the sensor and a page number of the processing-target page with each other and storing them;
calculating a distance between read images of pages on which the same type of defect is detected based on the timing information on the page on which the same type of defect is detected at the same width position of the printing medium among all pages for which double-sided printing has been performed in the printing unit; and
determining the periodicity of the same type of defect based on the calculated distance.

4. The printing apparatus according to claim 3, wherein
in the determining:
for the plurality of the same types of defect detected at the same width position, page numbers of the pages on which the same type of defect is detected are converted into image formation order;
the obtained image formation order is converted into the timing information; and
based on the converted timing information, the distance between the read images of the pages on which the same type of defect is detected is calculated.

5. The printing apparatus according to claim 1, wherein
the one or more processors further execute the instructions to perform:
identifying a trouble portion in the printing unit based on periodicity obtained by the determination.

6. The printing apparatus according to claim 5, wherein
information representing a period distance of each part configuring the printing unit is referred to and in a case where the calculated distance matches with the period distance of one of the parts, the part is identified as a trouble portion.

7. The printing apparatus according to claim 1, wherein
the one or more processors further execute the instructions to perform:
determining an operation mode to be applied before the printing unit starts the double-sided printing.

8. The printing apparatus according to claim 7, wherein
the operation mode to be applied is determined depending on whether scaling processing is necessary, which adjusts magnification of an image to be formed on each of the observe side and the reverse side in a case where the double-sided printing is performed.

9. The printing apparatus according to claim 8, wherein
the two operation modes are an alternate double-sided mode whose throughput is relatively high and a cyclic double-sided mode whose throughput is relatively low and
in a case where the scaling processing is necessary, the alternate double-sided mode is determined and in a case where the scaling processing is not necessary, the cyclic double-sided mode is determined.

10. The printing apparatus according to claim 1, wherein
the type of defect includes a spot-shaped defect and a linear defect.

11. A printing apparatus comprising:
a printing unit configured to perform printing on a printing medium by using color materials, and having a double-sided printing function with two operation modes in which processing order of pages is different;
a reading unit configured to generate a read image by reading a printed medium output from the printing unit;
an inspection unit configured to inspect whether or not there is a defect on the printed medium based on the read image; and
a communication unit configured to communicate with an external device, the printing apparatus further comprising:
one or more memories storing instructions; and
one or more processors executing the instructions to perform:
transmitting inspection results by the inspection unit for a plurality of the printed printing media output successively to the external device; and
receiving information on periodicity of a defect detected in the inspection results from the external device, wherein
the periodicity is determined based on results of processing that is in accordance with an operation mode in a case where double-sided printing is performed in the printing unit and which achieves consistency between page order in a case where printing is performed in the printing unit and page order in a case where reading is performed in the reading unit.

12. The printing apparatus according to claim 11, wherein
the one or more processors further execute the instructions to perform:
receiving information on a trouble portion in the printing unit, which is identified based on the periodicity obtained by the determination, from the external device.

13. The printing apparatus according to claim 12, wherein
information representing a period distance of each part configuring the printing unit is referred to and in a case where a calculated distance matches with the period distance of one of the parts, the part is identified as a trouble portion.

14. A printing system including an external device and a printing apparatus performing print processing, the printing apparatus comprising:
a printing unit configured to perform printing on a printing medium by using color materials, and having a double-sided printing function with two operation modes in which processing order of pages is different;
a reading unit configured to generate a read image by reading a printed medium output from the printing unit;
an inspection unit configured to inspect whether or not there is a defect on the printed medium based on the read image;
a communication unit configured to communicate with the external device; one or more memories storing instructions; and
one or more processors executing the instructions to perform:
transmitting inspection results by the inspection unit for a plurality of the printed printing media output successively to the external device; and
receiving information on periodicity of a defect detected in the inspection results from the external device, and the external device comprising:
one or more memories storing instructions; and
one or more processors executing the instructions to perform:
determining the periodicity by performing processing that is in accordance with an operation mode in a case where double-sided printing is performed in the printing unit and which achieves consistency between page order in a case where printing is performed in the printing unit and page order in a case where reading is performed in the reading unit based the received inspection results; and
transmitting results of the determination to the printing apparatus.

15. A control method of a printing apparatus having a double-sided printing function, the control method comprising:
performing printing on a printing medium by using color materials;
generating a read image by reading a printed medium;
inspecting whether or not there is a defect on the printed medium based on the read image; and
determining periodicity of a detected defect based on results in the inspecting for a plurality of the printed printing media output successively, wherein
the double-sided printing function includes two operation modes in which processing order of pages is different and
in the determining, the periodicity of the defect is determined by performing processing that is in accordance with an operation mode in a case where double-sided printing is performed and which achieves consistency between page order in a case where the double-sided printing is performed and page order in a case where reading of the printed medium is performed.
